(19) United States
(12) Patent Application Publication
(10) Pub. No.: US 2010/0089307 A1
(43) Pub. Date: Apr. 15, 2010

(54) SOUND SYNTHESIZER SYSTEM FOR USE IN A VEHICLE HAVING AN INTERNAL COMBUSTION ENGINE

(75) Inventor: Steven Kenchington, Norwich (GB)

Correspondence Address: FULWIDER PATTON LLP, HOWARD HUGHES CENTER, 6060 CENTER DRIVE, TENTH FLOOR, LOS ANGELES, CA, 90045, US

(73) Assignee: LOTUS CARS LIMITED, Norwich, Norfolk, NR, GB (GB)

(21) Appl. No.: 12/523,923

(22) PCT Filed: Jan. 23, 2008
(86) PCT No.: PCT/GB08/00230

§ 371 Date: Oct. 21, 2009

(30) Foreign Application Priority Data
Jan. 23, 2007 (GB) 0701268.5

(51) Int. Cl. B60Q 5/00; H04B 1/00

(52) U.S. Cl. 116/28 R; 381/86; 381/61

(57) ABSTRACT

With reference to FIG. (1), the present invention relates to a sound synthesizer system for use in a vehicle having an internal combustion engine. The system comprises a sound synthesizer unit (12) operable to produce sound signals by generating and combining signals of different frequencies, a speed sensor (10) for providing a speed of revolution signal indicative of speed of revolution of the internal combustion engine of the vehicle, and an inclinometer (11) attachable to a throttle control of the internal combustion engine which provides an inclination signal indicative of inclination of the throttle control. The sound synthesizer unit (12) receives the speed of revolution signal from the speed sensor (10) and the inclination signal from the inclinometer (11) and uses both signals to determine what sound signals are produced thereby, the sound synthesizer) unit (12) varies the sound signals with changes in the speed of revolution signal and changes in the inclination signal.

The present invention relates to a sound synthesizer system for use in a vehicle having an internal combustion engine.

DE-A-3420463 discloses a sound enhancement system for a vehicle in which an engine speed proportional frequency signal is taken from an ignition coil and fed to a frequency changer which changes the frequency and generates an output which is selectable by a switch to drive a loudspeaker via an adjustable amplifier. The vehicle sound simulated depends upon the frequency selected. The system is, however, limited in that only a single frequency can be generated at a time and a complex sound cannot be generated in response to a range of vehicle operating conditions.

EP-A-0469023 describes a sound synthesizer having a sound source which stores signals representing vehicle operating sounds. The sound synthesizer is responsive to the operation of the vehicle and its engine to provide simulated vehicle operating sounds which vary with engine speed and with vehicle operation. The sounds heard by a user of the synthesizer can represent the sounds of a racing car or other high performance road vehicle. The sounds are heard by the occupants of the cabin of the vehicle whilst the vehicle is being driven so as to enhance the occupant's driving experience. For instance, the sounds of a high powered engine undergoing sharp acceleration can be produced in response to the acceleration of a vehicle. The sound synthesizer is described as typically integrated with the in-car entertainment (i.c.e.) system.

WO 2006/06832 describes a sound synthesizer for an automobile which has a memory store for storing audio data files and a FM transmitter for transmitting the sounds to a stereo system of a vehicle. The sound synthesizer is provided in a compact casing mountable on a vehicle dashboard. The unit can be powered by the 12 volt vehicle battery. A detector for detecting an output level of the vehicle engine can be connected to the unit's process or by a wireless link. Detected parameters include the speed of revolution of the engine, induction coil pulses throttle position, manifold vacuum pressure and brake, clutch and gear positions. The unit can have a removable memory card. The unit can be integrated into a vehicle stereo system. The document does not disclose how to measure throttle position. The document teaches that the revolutions per minute are measured by an induction coil surrounding a spark plug lead, by a magnetic or optical sensor or by a detector detecting pulses from an engine control unit.

GB 2354872 discloses a sound synthesizer for generating a high performance sports car sound in a conventional saloon. The sounds generated are of a frequency proportional to engine speed. Unconventional sounds can be generated, e.g. of a motorbike, steam engine, jet engine. The car's entertainment system loudspeakers can be used to generate the sound. An audio cassette adapter can be used to output the signal of the synthesizer into the in-car entertainment system via the cassette slot. The synthesizer is powered by the vehicle's 12 volt electronics, e.g. via a cigar lighter socket. Different output sounds can be selected by the user. A throttle position sensor is used to provide an input to the synthesizer. It is a simple on/off tilt switch which indicates when the throttle pedal is depressed or released. It is connected by wire to the synthesizer. It is strapped to the throttle pedal arm. An engine signal is also provided as an optical or magnetic sensor with a toothed wheel driven by the engine.

The design of the sound synthesizers of the prior art makes them difficult to retro-fit to an existing vehicle or install in an existing design of vehicle.

In a first aspect, the present invention provides a sound synthesizer system for use in a vehicle having an internal combustion engine comprising:

a sound synthesizer unit operable to produce sound signals;

a speed sensor for providing a speed of revolution signal indicative of speed of revolution of the internal combustion engine of the vehicle; and

an inclinometer attachable to a throttle control of the internal combustion engine which provides an inclination signal indicative of inclination of the throttle control; wherein:

the sound synthesizer unit receives the speed of revolution signal from the speed sensor and the inclination signal from the inclinometer and uses both signals to determine what sound signals are produced thereby, the sound synthesizer unit varying the sound signals with changes in the speed of revolution signal and changes in the inclination signal;

the inclinometer has a user-adjustable attachment mechanism which enables a user to both attach the inclinometer to the throttle control and set an orientation of the inclinometer once attached; and

the sound synthesizer has an inclinometer initialisation system comprising a user-operable control which is used to start initialisation and an inclination monitoring system which monitors the inclination signal in the period following start of initialisation as the throttle control is moved through a range of movement normal thereto, the monitoring system indicating to the user whether variance in the inclination signal throughout the range of throttle control movement is acceptable and thus the inclinometer correctly attached to the throttle control or whether variance in the inclination signal throughout the range of throttle control movement is unacceptable and therefore adjustment of orientation of the inclinometer is needed.

In a second aspect, the present invention provides a sound synthesizer system for use in a vehicle having an internal combustion engine, comprising:

a sound synthesizer unit operable to produce sound signals;

a speed sensor for providing a speed of revolution signal indicative of speed of revolution of the internal combustion engine of the vehicle; and

an inclinometer attachable to a throttle control of the internal combustion engine which provides an inclination signal indicative of inclination of the throttle control; wherein:

the sound synthesizer unit receives the speed of revolution signal from the speed sensor and the inclination signal from the inclinometer and uses both signals to determine what sound signals are produced thereby, the sound synthesizer unit varying the sound signals with changes in the speed of revolution signal and changes in the inclination signal; and

the synthesizer unit is provided with an adjustable filter for filtering the speed of revolution signal, the filter being adjustable to facilitate use of the synthesizer system with internal combustion engines of varying numbers of cylinders, the filter being adjustable to filter out different harmonies depending on the engine configuration so that for each engine configuration a speed of revolution signal of an appropriate frequency spectrum is allowed to pass the filter to be used to control the sound signals produced by the synthesizer unit.

A preferred embodiment of the present invention will be described below by way of example with reference to the accompanying drawings which is a block circuit diagram of a sound synthesizer system according to a first embodiment of the present invention.

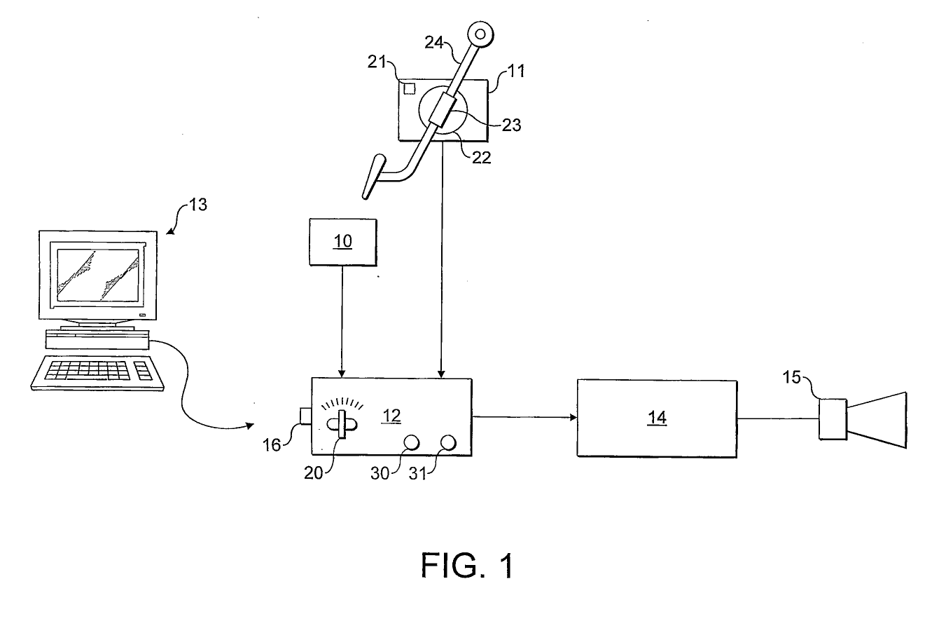

FIG. 1 shows a sound synthesizer unit 12 which produces sound signals to be relayed to an in-car entertainment (i.c.e.) system 14 of a vehicle and then on to loudspeakers in the vehicle cabin, such as loudspeaker 15.

The sound synthesizer unit 12 receives two input signals, a first input signal indicating the speed of revolution of the engine (r.p.m) from a speed of revolution sensor 10 and a second signal indicating the inclination angle of a throttle pedal of the vehicle, provided by an inclinometer 11.

The signal indicating the speed of revolution of the engine is a Hall effect sensor which detects current flow to spark plugs of the engine, by measuring the magnetic field pulse of the coil pack(s) connected to the spark plugs. This is suitable for all types of petrol engines; e.g. wasted spark, distributor, individual coil packs.

The sound synthesizer unit 12 unit of the preferred embodiment is portable and will be of a size comparable to portable MP3 players already known.

Many vehicles are now provided with an i.c.e. system 14 which has an MP3 socket to enable an MP3 player to be plugged into the i.c.e. system so that music stored on the MP3 player can be heard in the vehicle. The sound synthesizer unit 12 can be connected to the i.c.e. system 14 via a lead which plugs into the MP3 socket of the i.c.e. system 14. Alternatively, the sound synthesizer unit 12 could be connected to the i.c.e. system via a connector which can be inserted into a cassette player of the i.c.e. system 14 so that signals generated by the sound synthesizer unit 12 are relayed to the i.c.e. system 14 and then played through the i.c.e. system 14. Additionally or alternatively, the link between the sound synthesizer unit 12 and the i.c.e. system 14 need not be a hard wired link at all and instead the sound synthesizer unit 12 could be provided with a short-range radio transmitter which can emit sound signals on a radio frequency capable of being received by a radio part of the i.c.e. system 14 so that a user can tune the i.c.e. system 14 into the correct frequency to receive signals from the sound synthesizer unit 12.

The sound synthesizer unit 12 has a computerised memory which stores signals of different frequencies which are generated and combined by the sound synthesizer unit 12 to produce the sound signals output thereby. The different frequency signals can be preprogrammed into the sound synthesizer unit 12. The sound synthesizer unit 12 illustrated has a USB port 16 enabling the sound synthesizer 12 to be connected to a personal computer 13 to receive sound files from the personal computer 13, e.g. from the Internet. Therefore signals of different frequencies can be downloaded into the memory of the sound synthesizer unit 12 from a website provided on the Internet via the personal computer 13 and through the USB port 16 of the sound synthesizer unit 12.

The signal frequencies stored in the memory of the sound synthesizer unit 12 will be stored in sets, each set representing typically be sounds of a vehicle. For instance, the sound of an engine of a high performance vehicle could be stored as one set of signals of varying frequencies in the memory of the sound synthesizer unit 12. However, the sounds stored need not only be vehicle sounds, but could be other sounds according to the driver's taste.

A user-operable selector 20 is provided for the synthesizer unit 12 and the selector 20 enables a user of the unit 12 to select between different sets of stored signal frequencies. In this way, the user can change the sound heard in the cabin, e.g. from the synthesized noise of one high-performance car to another or from a car noise to music whose volume and beat changes with changes in engine speed.

The speed of rotation sensor 10 is a simple induction sensor fitted around a low tension cable in the spark of a gasoline internal combustion engine. The device would simply clip around the low tension lead and would be easy to install. Alternatively, for a diesel engine the device could be clipped around the lead providing the diesel injection drive signal to a diesel injector.

In either case, but particularly in the case of a diesel engine, it would be beneficial to provide the sound synthesizer unit 12 with a filter for filtering the speed signal whose settings could be varied depending upon whether the vehicle engine is a 4-cylinder, 5-cylinder, 6-cylinder etc engine. This would provide the synthesizer unit 12 with a filtered speed signal in order that an appropriate drive signal could be provided to determine the signal output by the sound synthesizer 12. The filter settings are altered to suit engine type so that the signal used by the sound synthesizer is truly representative of engine speed.

The inclinometer 11 will be a device easily attached around the throttle pedal of a vehicle. The inclinometer 11 will measure an angle of inclination of the throttle pedal from any chosen datum and produce a signal indicating the measured angle. The inclinometer 11 is based on a duel-axis accelerometer. The sensor indicates its rotation from a datum position and is accurate to 1°. On initial installation the inclinometer 11 will be calibrated to set the datum, or zero degree, position. This is done by providing the inclinometer 11 with an adjustable attachment mechanism 22, 23 for attaching the inclinometer 11 to the throttle pedal. When the inclinometer is first attached then the adjustable attachment mechanism 22, 23 will be used to set the orientation of the inclinometer with respect to the throttle pedal in a way indicated by written instructions. Then the throttle pedal will be depressed through its full range of movement, typically 27-30°. This is done after pushing a calibration button 21 provided on the inclinometer 11. Once the pedal has gone through its travel then the output of the inclinometer during the pedal movement will be compared against stored data in the unit 12 and then an indication (such as a red 30 or green 31 light provided on the unit 12 or an audible sound emitted by the unit 12) will indicate whether the installation of the inclinometer is correct or incorrect. If the installation is incorrect then an adjustment of the orientation of the inclinometer is made using the adjustable attachment mechanism and the procedure repeated. The indication of correct installation is provided either by the lights 30, 31 visible on the casing of the sound synthesizer unit 12 or by the sound synthesizer unit 12 emitting a suitable signal to be heard through the loudspeaker e.g. 15. The adjustable mechanical attachment mechanism 22, 23 for attaching the inclinometer to the throttle pedal could comprise adhesive pads, tie wraps 23 and/or hoop and loop fastener pads.

The inclinometer 11, being based on a dual axis accelerometer, can provide an inclination measurement through 360° of rotation to 1° of accuracy. The inclinometer 11 measures 100% of throttle movement to allow engine loads to be completely mapped in the memory of unit 12.

The inclinometer 11 produces a pulse width modulated (PWM) signal to give a good signal-to-noise ratio. The signal is low pass filtered (either in the output stage of the inclinometer 11 or the input stage of the unit 12) so that high-frequency noises are eliminated, as are signals related to movement of the vehicle over different road surfaces.

For a more sophisticated method of installation, the inclinometer 11 could be connected by a lead into a lap top computer and the apparatus supplied with software for the laptop computer which enables the laptop computer to give a graphical display showing the inclination of the inclinometer and also assisting the user to correctly install the inclinometer.

The sound synthesizer unit 12 could be battery powered. Additionally, or alternatively, the sound synthesizer unit 12 could be provided with a lead to enable it to be connected to a 12-volt electrical supply, such supplies being common in vehicles.

The inclinometer 11 will be connected to the sound synthesizer unit 12 either via a hard wire or alternatively the inclinometer 11 will be provided with a radio frequency transmitter and the sound synthesizer unit 12 with a matched radio frequency receiver. The inclination signal would therefore be transmitted by a radio signal.

By fashioning the sound synthesizer unit 12 as a portable unit to be used inside the vehicle cabin, the unit 12 will be used in a safe protected environment (as opposed to under the bonnet, which is a harsh environment) and also the unit can be taken from vehicle to vehicle to be used in many vehicles and also the unit 12 can be easily plugged into a personal computer to download sounds.

It will be typical to provide the sound synthesizer unit 12 with a memory which contains a number of different sound files so that the user can use the selector 20 to select from a range of different sounds so that the user can make the sound in the cabin appear like a number of different vehicles or indeed could arrange for the sound synthesizer unit to produce sounds which are not vehicle-like in nature. Any sound could be emitted by the sound synthesizer. This is called having “multiple voices”. The memory will be provided either in a memory integral to the unit 12 or alternatively or additionally on a memory stick or memory card insertable into the unit 12. It is possible that the system could be arranged so that memory sticks or memory cards could be bought each with a different sound file so that the user could choose what sound is to be emitted by the sound synthesizer unit 12 by choosing what memory stick or memory card is inserted into the sound synthesizer unit 12. With such an arrangement there would be no need for the sound synthesizer unit 12 to have a USB port to connect the personal computer.

In an alternative embodiment of the present invention the sound synthesizer unit 12 is not portable, but is installed in the motor vehicle and connected by wire to the in-car entertainment system 14, or integrated with the in-car entertainment system 14. The benefits of using just two input sensors, a speed of revolution sensor 10 simply installed around a low tension cable or a fuel injector cable and an inclinometer 11 simply attached to the throttle pedal, apply equally to installations where the sound synthesizer unit 12 is permanently mounted within the vehicle as to any vehicle in which the sound synthesizer unit 12 is portable. The inclinometer 11 provides a very simple way of determining the load requested of the engine which does not require significant installation costs or redesign of the vehicle.

The sound synthesizer unit 12 will emit a sound which varies in dependence upon the speed of the engine and (by use of the inclinometer signal) in dependence of the load demanded by the driver. Thus, as the car accelerates, the noise heard by the occupants of the cabin will be that of e.g. an engine accelerating and the noise will change as the engine speed gets greater. The use of the throttle pedal inclinometer will allow the sound synthesizer unit to detect e.g. a change of gear and this will allow the sound synthesizer unit to generate sounds which match the gear change. Whilst it is envisaged that the noise emitted by the sound synthesizer unit 12 will be designed to make the inhabitants of the vehicle cabin hear a noise equivalent to e.g. a high-powered vehicle, it is also possible that the sound synthesizer unit 12 could be made to emit music which varies in volume, beat etc with changes in engine speed and load. The synthesizer could be used to give sound effects usually associated with computer games.

The system proposed by the invention is a simple system since it is an open-loop system rather than a closed-loop system. There are no microphones associated with the sound synthesizer unit 12 to provide a feedback signal indicative of the actual noise heard by the occupants of the vehicle cabin.

Above it is envisaged that the vehicle is a land vehicle, e.g. a car or a lorry, and the throttle control is a throttle pedal. However, the system could be used with other vehicles which have internal combustion engines, e.g. motor boats, in which case the throttle control would not be a foot-operated pedal, but a hand-operated lever.

Whilst above the speed of revolution sensor is described in a gasoline engine as a sensor installed around a low tension cable and this is an elegant solution, other non-contact engine speed measurement devices could be used. For instance, a sensor could be used to sense pulses sent in the fuel injection system of an engine with fuel injection; these could also give an indication of load in addition to the inclinometer signal in order to enhance the synthesis, since the presence and/or absence and frequency of pulses will give an indication of engine load. Such a sensor could be a Hall effect sensor, as described before.

1. A sound synthesizer system for use in a vehicle having an internal combustion engine, comprising:
a sound synthesizer unit operable to produce sound signals;
a speed sensor for providing a speed of revolution signal indicative of speed of revolution of the internal combustion engine of the vehicle; and
an inclinometer attachable to a throttle control of the internal combustion engine which provides an inclination signal indicative of inclination of the throttle control; wherein:
the sound synthesizer unit receives the speed of revolution signal from the speed sensor and the inclination signal from the inclinometer and uses both signals to determine what sound signals are produced thereby, the sound synthesizer unit varying the sound signals with changes in the speed of revolution signal and changes in the inclination signal;
the inclinometer has a user-adjustable attachment mechanism which enables a user to both attach the inclinometer to the throttle control and set an orientation of the inclinometer once attached; and
the sound synthesizer has an inclinometer initialisation system comprising a user-operable control which is used to start initialisation and an inclination monitoring system which monitors the inclination signal in the period following start of initialisation as the throttle control is moved through a range of movement normal thereto, the monitoring system indicating to the user whether variance in the inclination signal throughout the range of throttle control movement is acceptable and thus the inclinometer correctly attached to the throttle control or whether variance in the inclination signal throughout the range of throttle control movement is unacceptable and therefore adjustment of orientation of the inclinometer is needed.

2. A sound synthesizer system as claimed in claim 1 wherein the inclination monitoring system is included in the sound synthesizer unit and the sound synthesizer unit indicates to the user whether the variance in the inclination signal throughout the range of throttle control movement is acceptable.

3. A sound synthesizer system as claimed in claim 1 wherein the inclinometer provides output signal indicative of a measured throttle control angle.

4. A sound synthesizer system as claimed in claim 3 wherein the inclinometer indicates the measured throttle control angle in selected increments.

5. A sound synthesizer system as claimed in claim 1 which comprises a low pass filter which filters the inclination signal from the inclinometer.

6. A sound synthesizer system as claimed in claim 1 wherein the speed sensor comprises one or more Hall effect sensor(s) each of which detects current flow to one or more spark plug(s) of the engine by measuring magnetic field pulse(s) of coil pack(s) connected to the spark plug(s).

7. A sound synthesizer system as claimed in claim 1 wherein the sound synthesizer unit is a portable unit.

8. A sound synthesizer system as claimed in claim 7 wherein the sound synthesizer unit has an output lead for connecting the synthesizer unit to an entertainment system of the vehicle whereby the sound signals produced by the synthesizer unit can be relayed via the entertainment system to drive one or more loudspeakers in a cabin of the vehicle.

9. sound synthesizer system as claimed in claim 7 wherein the synthesizer unit has a radio frequency transmitter integrated therewith which broadcasts the sound signals produced thereby so that the broadcast signals can be received by a radio of the land vehicle and thereby played through one or more loudspeakers in a cabin of the vehicle.

10. A sound synthesizer system as claimed in claim 1, wherein:
the inclinometer is provided with a radio frequency transmitter for broadcasting the inclination signal; and the synthesizer unit is provided with a radio frequency receiver for receiving the broadcast inclination signal.

11. A sound synthesizer system as claimed in claim 10 wherein: the speed sensor is provided with a radio frequency transmitter for broadcasting the speed signal; and
the radio frequency receiver of the synthesizer additionally receives the broadcast speed signal.

12. A sound synthesizer system as claimed in claim 1 wherein: the speed sensor is provided with a radio frequency transmitter for broadcasting the speed signal; and the synthesizer unit is provided with a radio frequency receiver for receiving the broadcast speed signal.

13. A sound synthesizer system as claimed in claim 1 wherein the synthesizer unit is provided with an adjustable filter for filtering the speed of revolution signal, the filter being adjustable to facilitate use of the synthesizer system with internal combustion engines of varying numbers of cylinders, the filter being adjustable to filter out different harmonies depending on the engine configuration so that for each engine configuration a speed of revolution signal of an appropriate frequency spectrum is allowed to pass the filter to be used to control the sound signals produced by the synthesizer unit.

14. A sound synthesizer system as claimed in claim 1 wherein the synthesizer unit has a battery.

15. A sound synthesizer system as claimed in claim 1 wherein the synthesizer unit has a power lead that enables the synthesizer unit to be connected to an electrical power supply of the vehicle.

16. A sound synthesizer system as claimed in claim 1 wherein the synthesizer unit has a memory unit which functions as a source of the different frequencies used by the synthesizer unit in producing the sound signals.

17. A sound synthesizer system as claimed in claim 16 wherein the memory unit stores a plurality of different sets of frequencies and the synthesizer unit is provided with a selector which enables a user to select between the sets of frequencies to change the sound signals produced by the synthesizer unit.

18. A sound synthesizer system as claimed in claim 16 wherein the synthesizer unit has a data input port which enables downloading of frequencies into the memory unit for storing therein.

19. A sound synthesizer system as claimed in claim 16 wherein the memory unit is at least in part replaceable by a user of the synthesizer system whereby replacing the memory unit or part thereof with a new memory unit or part thereof enables the user to change the stored frequencies.

20. A sound synthesizer system as claimed in any one of claims 16 to 18 wherein the memory unit is at least in part replaceable by a user of the synthesizer system whereby replacing the memory unit or part thereof with a new memory unit or part thereof enables the user to change the stored frequencies.

21. A sound synthesizer system for use in a vehicle having an internal combustion engine, comprising: a sound synthesizer unit operable to produce sound signals; a speed sensor for providing a speed of revolution signal indicative of speed of revolution of the internal combustion engine of the vehicle; and an inclinometer attachable to a throttle control of the internal combustion engine which provides an inclination signal indicative of inclination of the throttle control; wherein: the sound synthesizer unit receives the speed of revolution signal from the speed sensor and the inclination signal from the inclinometer and uses both signals to determine what sound signals are produced thereby, the sound synthesizer unit varying the sound signals with changes in the speed of revolution signal and changes in the inclination signal; and the synthesizer unit is provided with an adjustable filter for filtering the speed of revolution signal, the filter being adjustable to facilitate use of the synthesizer system with internal combustion engines of varying numbers of cylinders, the filter being adjustable to filter out different harmonies depending on the engine configuration so that for each engine configuration a speed of revolution signal of an appropriate frequency spectrum is allowed to pass the filter to be used to control the sound signals produced by the synthesizer unit.

22. A sound synthesizer system as claimed claim 21 wherein the sound synthesizer unit is a portable unit.

23. A sound synthesizer system as claimed in claim 21 wherein the synthesizer unit has a radio frequency transmitter integrated therewith which broadcasts the sound signals produced thereby so that the broadcast signals can be received by a radio of the land vehicle and thereby played through one or more loudspeakers in a cabin of the vehicle.

24. A sound synthesizer system as claimed in claim 21 wherein:
the speed sensor is provided with a radio frequency transmitter for broadcasting the speed signal; and the synthesizer unit is provided with a radio frequency receiver for receiving the broadcast speed signal.

25. A sound synthesizer system as claimed in claim 21 wherein the speed sensor comprises an inductive sensor securable around a low tension ignition cable of the internal combustion engine.

26. A sound synthesizer as claimed in claim 21 wherein the speed sensor comprises one or more Hall effect sensor(s) each of which detects current flow to one or more spark plug(s) of the engine by measuring magnetic field pulse(s) of coil pack(s) connected to the spark plug(s).

27. A sound synthesizer system as claimed in claim 21 wherein the synthesizer unit has a memory unit which functions as a source of different frequencies used by the synthesizer unit in producing the sound signals.

28. A sound synthesizer system as claimed in claim 27 wherein the memory unit stores a plurality of different sets of frequencies and the synthesizer unit is provided with a selector which enables a user to select between the sets of frequencies to change the sound signals produced by the synthesizer unit.
